(19) United States
(12) Patent Application Publication
(10) Pub. No.: US 2010/0000317 A1
(43) Pub. Date: Jan. 7, 2010

(54) DEVICE FOR INDICATING A LEVEL OF FLUID COMPRISING A MOVABLE ARRANGED LIGHTING MEMBER WHICH IS PRESENT INSIDE A CONTAINER OF THE DEVICE

(75) Inventors: Andries Bron, Eindhoven (NL); Jacob Dijkstra, Eindhoven (NL); Cathrine Movold, Lund (SE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/440,245

(22) PCT Filed: Sep. 10, 2007
(86) PCT No.: PCT/IB2007/053626

§ 371 Date: Mar. 6, 2009

(30) Foreign Application Priority Data
Sep. 11, 2006 (EP) 06120411.1

(51) Int. Cl. G01F 23/36

(52) U.S. Cl. 73/313

(57) ABSTRACT

An electric hot water kettle comprises a container (2) for containing water to be heated. In order to provide a user of the kettle with information regarding a level of water that is present inside the container (2), the kettle comprises water level indication means (10). These means (10) comprise a lighting member (20) having at least one light (21) and a float (30) which is capable of floating on water, and which is arranged in the container (2). The lighting member (20) is arranged in the float (30), so that the at least one light (21) moves along with the water surface by means of the float (30), as a result of which a most accurate indication of the water level is obtained. The at least one light (21) of the lighting member (20) is powered by a pickup coil (57) arranged in the float (30), wherein an inductive coupling between the pickup coil (57) and a coil (55) connected to the mains (52) exists.

### FIELD OF THE INVENTION

The present invention relates to a device having a container for containing fluid, and means for indicating a level of fluid which is present inside the container, wherein the fluid level indicating means comprise a lighting member having at least one light for emitting light.

The present invention also relates to fluid level indicating means for a device having a container for containing fluid, comprising a float that is adapted to floating on the fluid, and a lighting member having at least one light for emitting light.

### BACKGROUND OF THE INVENTION

Various types of domestic appliances, including hot water kettles and coffee makers, comprise a water tank for containing water. In many cases, this water tank is detachably arranged with respect to the rest of the appliance, so that it is possible to take the water tank to a tap or the like for the purpose of filling the water tank with water. For the purpose of enabling a user of the appliance to determine a suitable moment for filling the water tank, it is important that it is possible for a user to check the level of the water that is present inside the water tank, preferably without needing to remove the water tank from the rest of the appliance. For example, the water tank may be at least partially transparent in order to enable a user of the appliance to check the water level. It is also possible that the appliance comprises a specific indicator for providing an indication of the water level. Such an indicator may be a floating colored object, for example, which floats on the fluid, and which can be viewed through a viewing window.

In the following, three known examples of means for indicating a level of fluid that is present inside a tank or container will be described. It is noted that in all three examples, the fluid level indicating means comprise a lighting member having at least one light for emitting light.

US 2005/0109105 A1 discloses an indicator assembly for indicating the level of a fluid in a tank, which includes at least one column of lights that is turned on or off as the level of fluid in the tank rises and falls. The lights may be turned on and off by the passage of a magnetic float that changes the state of magnetically actuated switches which are associated in a one-to-one relationship with the lights.

US 2003/0159588 A1 discloses an illuminated jug kettle that incorporates a window formed in at least part of an outer wall of a body of the kettle, and at least one light source fixed to an inner surface of the kettle at a position spaced apart from the window and above a maximum fluid level. The light source is used for illuminating the top surface of any fluid contained in the kettle body, as a result of which a user of the kettle is enabled to read the fluid level within the kettle through the window.

GB 2 332 522 A discloses a level indication device that may be part of an appliance such as an electric kettle or a hot water jug, for example. The level indication device comprises a tubular fluid chamber which is located in a recess in an outer wall of a container portion of the appliance, and which is connected so that the fluid level is the same in the fluid chamber as in the container. At one end of the fluid chamber, a light source is provided for illuminating the fluid that is present inside the fluid chamber and surrounding walls of the fluid chamber, so as to make the fluid level easier to see. In order to enhance the visibility of the fluid level even further, a reflective float may be provided inside the fluid chamber.

### SUMMARY OF THE INVENTION

It is an objective of the present invention to provide an appealing and reliable alternative for the known means of indicating a fluid level. This objective is achieved by a device having a container for containing fluid, and means for indicating a level of fluid which is present inside the container, wherein the fluid level indicating means comprise a movably arranged lighting member having at least one light for emitting light, and linking means for establishing a direct link between a position of the lighting member to a level of the fluid which is present inside the container.

According to the present invention, the lighting member which is part of the fluid level indicating means is movably arranged, and linking means for establishing a direct link between a position of the lighting member and a level of the fluid that is present inside the container are provided, so that it is ensured that the position of the lighting member varies along with the position of the fluid level. In this way, the lighting member provides a reliable indication of the fluid level under all circumstances. Furthermore, the indication is clearly visible, due to the fact that at least one light is at the level of the fluid.

For sake of completeness, it is noted that the device having a container and the fluid level indicating means may be a domestic appliance such as a hot water kettle, a coffee maker, or a water cooler, for example.

In a preferred embodiment of the device according to the present invention, the linking means comprise a float that is adapted to float on the fluid. In general, it is true that using a float is a relatively easy and very reliable manner of determining a fluid level. In a practical application, the float may be slidably arranged on a guide, so that the float is prevented from moving in a sideward direction.

An advantageous possibility existing within the context of the present invention is the possibility of arranging the lighting member in the float. In that case, the required direct link between the position of the lighting member to the fluid level is surely guaranteed, as the lighting member is made to float on the fluid. It will be understood that it is important for a float that is used for accommodating the lighting member to be at least partially light transparent.

For the purpose of supplying electric power to the lighting member, it is preferred for the device to comprise means for supplying power to the lighting member, wherein the power supplying means comprise a combination of a member for transmitting power and a member for receiving power transmitted by the power transmitter, wherein the power transmitter is arranged in a wall of the container, and wherein the power receiver is arranged in the float and coupled to the lighting member. For example, the power transmitter and the power receiver may be coupled through an electric wire. Such a wire needs to be at least the height of the container, so that the at least one light of the lighting member is powered at both the higher levels and the lower levels of the fluid inside the container. Furthermore, it is important to have a watertight connection of the wire to the float.

In view of the difficulties associated with a wired connection between the power transmitter and the power receiver, it is preferred to have wireless transmission of power. This is realized when the power transmitter and the power receiver are coupled through a capacitive link, or an inductive link, for example. In the latter case, both the power transmitter and the power receiver comprise a coil. The coil of the power transmitter may be a relatively large coil mounted in the container wall, so that the at least one light of the lighting member may always be powered, independent of the fluid level. The coil of the power receiver may be winded over an E-like core, for example, in order to capture sufficient flux for powering the at least one light. According to another option, the power receiver may be arranged on a ferrite rod for closing the inductive loop and to prevent too much electric and magnetic field radiation. In that case, the ferrite rod may also be used for guiding the float.

Besides the above-described embodiments in respect of powering the at least one light of the lighting member, it is also possible to use energy storing means such as a battery or a capacitor for supplying the required power, wherein the lighting member is coupled to the energy storing means, and wherein the energy storing means are coupled to the power receiver. For the purpose of charging the energy storing means, the above-described power receiver in the form of a coil may be applied.

It may not only be desirable to indicate a level of the fluid in the container, but also to indicate an orientation of the fluid surface. This may be realized by means of a lighting member having a number of lights, which are positioned in a row, wherein the direction in which the row is extending is an indication of the orientation of the fluid surface. Assuming that the lighting member is arranged in a float, it is advantageous to have a member for guiding the float, wherein the float has a hole for letting through the guiding member, wherein the float is slid ably arranged with respect to the guiding member, and wherein the float is also pivotally arranged with respect to the guiding member. Due to this arrangement, it is possible to change the orientation of the float with respect to the guiding member, along with the orientation of the fluid surface. It is noted that such a change takes place when a user tilts the container for the purpose of pouring out the fluid, for example.

In many cases, it is advantageous to use at least one light emitting diode (LED) as the at least one light of the lighting member. When LEDs are applied in an environment where the temperature may raise above the boiling point of water, which is the case when LEDs are applied in a hot water kettle, for example, it is important to use LEDs that are capable of withstanding such temperatures.

It is noted that it is possible for the lighting member to have other lights than LEDs, although the application of LEDs is preferred in view of their small size and high durability. For example, the lighting member may comprise a standard incandescent lamp such as an indicator light bulb.

Within the scope of the present invention, when the fluid level indicating means comprise a float, it is possible to arrange the lighting member outside of the float, and to provide a link between the lighting member and the float. This link may be established in a mechanical manner or by means of a magnet that is arranged in the float and a magnet that is attached to the lighting member, for example.

The above-described and other aspects of the present invention will be apparent from and elucidated with reference to the following description of a hot water kettle and a number of embodiments of fluid level indicating means of the kettle.

### BRIEF DESCRIPTION OF THE DRAWINGS

The present invention will now be explained in greater detail with reference to the figures, in which the same reference signs indicate equal or similar parts, and in which:

FIG. 1 diagrammatically shows a hot water kettle;

FIGS. 2 and 3 diagrammatically show a first advantageous embodiment of water level indicating means for use in the hot water kettle;

FIG. 4 is a block diagram illustrating a way in which power is supplied to a lighting member of the water level indicating means;

FIG. 5 diagrammatically shows a coil and an E-like core, which are part of means for supplying power to the lighting member;

FIG. 6 diagrammatically show a second advantageous embodiment of water level indicating means for use in the hot water kettle; and

FIGS. 7 and 8 diagrammatically show a number of components of a third advantageous embodiment of water level indicating means for use in the hot water kettle.

### DETAILED DESCRIPTION OF EMBODIMENTS

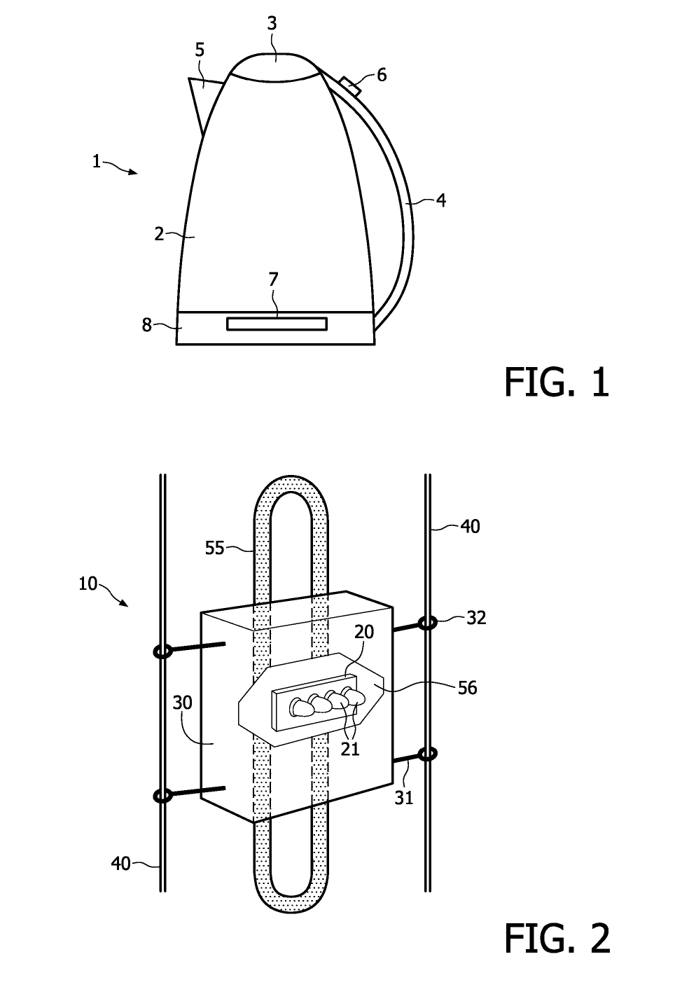

FIG. 1 diagrammatically shows an electric hot water kettle 1, which is suitable to be used for boiling water. The hot water kettle 1 comprises a container 2 for containing water, which is closable by means of a hingeably arranged lid 3, a handle 4 which is adapted to be taken hold of by a user of the kettle 1, and a water outlet part 5. Furthermore, the hot water kettle 1 comprises a button 6 for enabling the user to operate an on/off switch (not shown) of the kettle 1, and an electric heating element 7 for supplying heat to water that is present inside the container 2. In the shown example, the heating element 7 is arranged in a bottom section 8 of the container 2.

The hot water kettle 1 as shown may comprise an electric cord and a plug for connecting an electronics circuit (not shown) of the kettle 1 to the mains. However, it is also possible that the hot water kettle 1 is a so-called cordless kettle 1, wherein a base element (not shown) is provided for supporting the kettle 1, and wherein the base element comprises the electric cord and the plug. In such case, both the kettle 1 and the base element comprise connecting means for establishing an electric connection when the kettle 1 is put in place on the base element. An important advantage of the application of a separate base element is that a user of the kettle 1 is free to take the kettle 1 and to transport the kettle 1, without experiencing any hindrance of an electric cord.

According to the present invention, the hot water kettle 1 comprises means for indicating a level of water which is present inside the container 2, so that a user of the kettle 1 may know whether the container 2 needs filling, or not. In the following, various embodiments of suitable water level indicating means will be explained. In all of these embodiments, at least one light is arranged such as to exactly move along with the water surface.

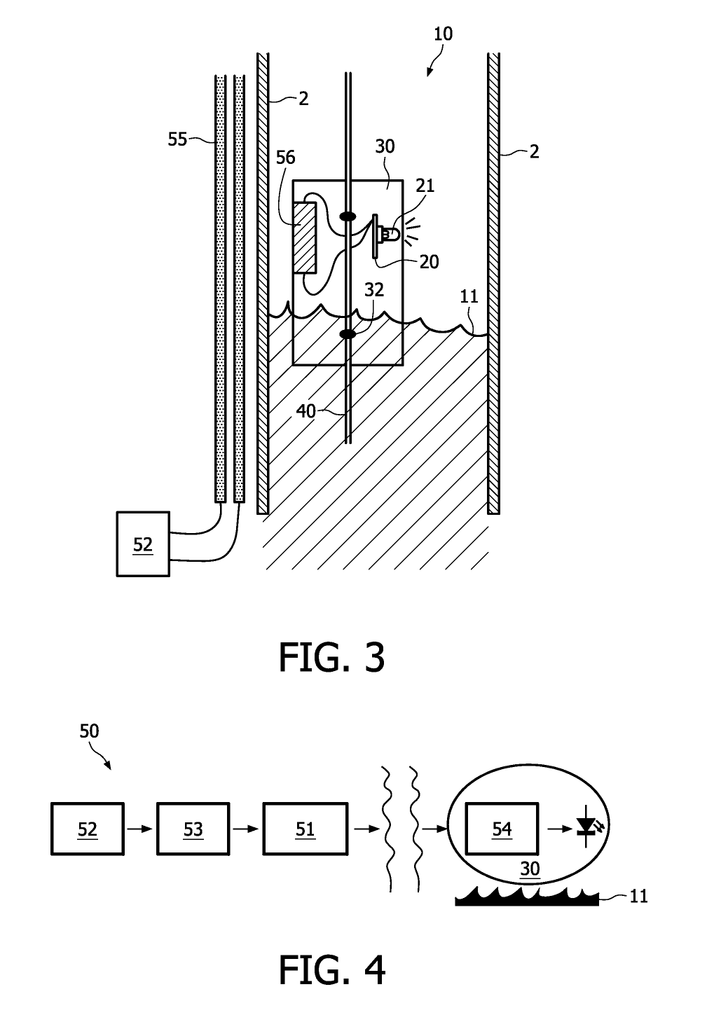

FIGS. 2 and 3 show a first advantageous embodiment of water level indicating means 10 for use in the hot water kettle 1. The water level indicating means 10 comprises a lighting member 20 having a number of LEDs 21 arranged in a row, and a float 30, wherein the lighting member 20 is arranged inside the float 30. Furthermore, the water level indicating means 10 comprise two substantially parallel guiding wires 40 for guiding the float 30, wherein the float 30 is equipped with two pairs of arms 31 having eyes 32 at their ends for enclosing the guiding wires 40. Due to this configuration, the float 30 is only movable in a direction in which the guiding wires 40 are extending.

The float 30, including the lighting member 20 and other components embedded therein, is capable of floating on water. In order to prevent the embedded lighting member 20 and the other components from getting wet, the float 30 is watertight. Furthermore, the float 30 is at least partially transparent, so that light emitted by the LEDs 21 may be visible at the outside of the float 30. The assembly of the float 30 and the guiding wires 40 is positioned in the container 2 of the hot water kettle 1, near a wall of the container 2. It is also possible for the container 2 to have a separate section for accommodating the float 30 and the guiding wires 40, wherein it is important that the section is in communication with the rest of the container 2, such that a water level in the section corresponds to a water level in the container 2.

In the hot water kettle 1, due to the fact that the lighting member 20 is arranged in the float 30, and the float 30 floats on water which is present in the container 2 or in an associated section, a level at which the row of lights 21 of the lighting member 20 is extending is indicative of the water level. For the purpose of enabling a user of the kettle 1 to notice the row of lights 21, the container 2 may be provided with a transparent viewing window, for example. Another possibility within the scope of the present invention is to not apply a viewing window, but to let the light emitted by the lights 21 of the lighting member 20 shine through a wall of the container 2, provided that the wall of the container 2 comprises material which is capable of at least letting through some light. The indication of the water level takes place in the most accurate manner, as the position of the lights 21 is directly coupled to the water level through the float 30. The water level indicating means 10 according to the present invention constitute an improvement over known water level indicating means having a lighting member 20, as when the known means are applied, it is often necessary to first measure the water level and interpret the measuring result to a digital readout.

In order to have the LEDs 21 emit light, the LEDs 21 need to be powered. To this end, power supplying means 50 are provided, comprising a power transmitter 51 that is connected to the mains 52, through a power adjustor 53, and a power receiver 54, which is adapted to receive power transmitted by the power transmitter 51. The components of the power supplying means 50 are diagrammatically shown in FIG. 4, which further diagrammatically shows the float 30 and a water surface 11. It is noted that the water level is determined by a position of this water surface 11.

The power supplying means 50 need to be capable of powering the LEDs 21 in every possible position. For example, at a relatively low water level, the power needs to available near a bottom of the container 2, and at a relatively high water level, the power needs to be available at a top side of the container 2. One way to realize a power supply under all possible circumstances is to connect an electric wire (not shown) between the power transmitter 51 and the power receiver 54, wherein the wire needs to be at least as long as a height of the container 2. When the possibility of applying a wire is put to practice, it is important to take measures aimed at ensuring a watertight construction.

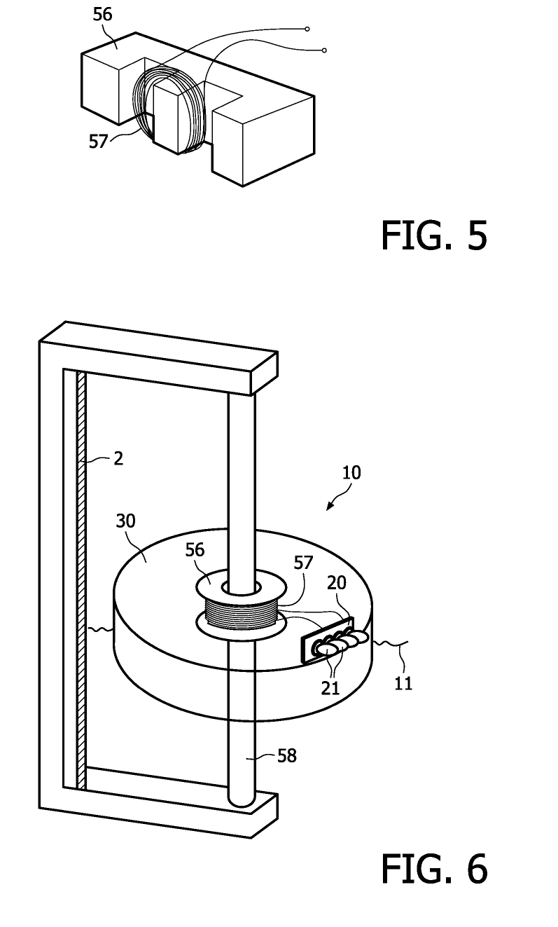

Preferably, a transmission of power from the power transmitter 51 to the power receiver 54 takes place in a wireless manner. For example, a capacitive link or an inductive link may be present between the power transmitter 51 and the power receiver 54. In order to realize an inductive link, coils may be used. FIGS. 2 and 3 illustrate the application of a relatively large coil 55 at the side of the power transmitter 51, extending along a substantial portion of the height of the container 2. Furthermore, FIGS. 2 and 3 illustrate the application of a ferrite element 56 with a coil 57 for picking up the power transmitted by the relatively large coil 55. The pickup coil 57 may be winded over an E-like core 56 such as a core which is known by those skilled in the art as RM core, so that sufficient flux is captured to power the LEDs 21. As an illustration of this possibility, an E-like core 56 and the pickup coil 57 are diagrammatically shown in FIG. 5.

FIG. 6 shows a second advantageous embodiment of water level indicating means 10 for use in the hot water kettle 1. In this embodiment, the power supplying means 50 comprise a ferrite rod core 58, wherein the pickup coil 57 for powering the LEDs 21 is winded over this rod core 58. Furthermore, in this embodiment, the rod core 58 is used for closing the inductive loop, wherein too much electric and magnetic field radiation is prevented. It is noted that in FIG. 6, for sake of clarity, the relatively large coil 55 for transmitting power to the pickup coil 57 is not shown.

The ferrite rod core 58 is mounted in a plastic housing. Due to the presence of the rod core 58, the guiding wires 40 for guiding the float 30 may be omitted, as the rod core 58 may be used for guiding the float 30. To this end, the float 30 is provided with a hole, wherein the rod core 58 is extending through the hole.

It is not necessary to use a pickup coil 57 for the purpose of powering the LEDs 21, as it is also possible to use a battery or a super capacitor for this purpose. In such a case, a pickup coil 57 may still be applied, namely for the purpose of charging the battery or super capacitor, wherein the LEDs 21 are connected to the battery or super capacitor.

The container 2 may be a portable component of a device. For example, the container 2 may be a water tank of a domestic coffee maker or the like, which is removable arranged in order to enable a user of the device to take the water tank to a tap for filling. In such a case, it is advantageous to apply a battery or super capacitor for powering the LEDs 21 so the LEDs 21 may still be operated when the container 2 is temporarily removed from the device, and, as a result, temporarily disconnected from the mains 52. For example, when a super capacitor having a capacity of about 200 J is used, and the LEDs 21 consume about 100 mW, the LEDs 21 may operate 2000 seconds on the super capacitor, which is about half an hour.

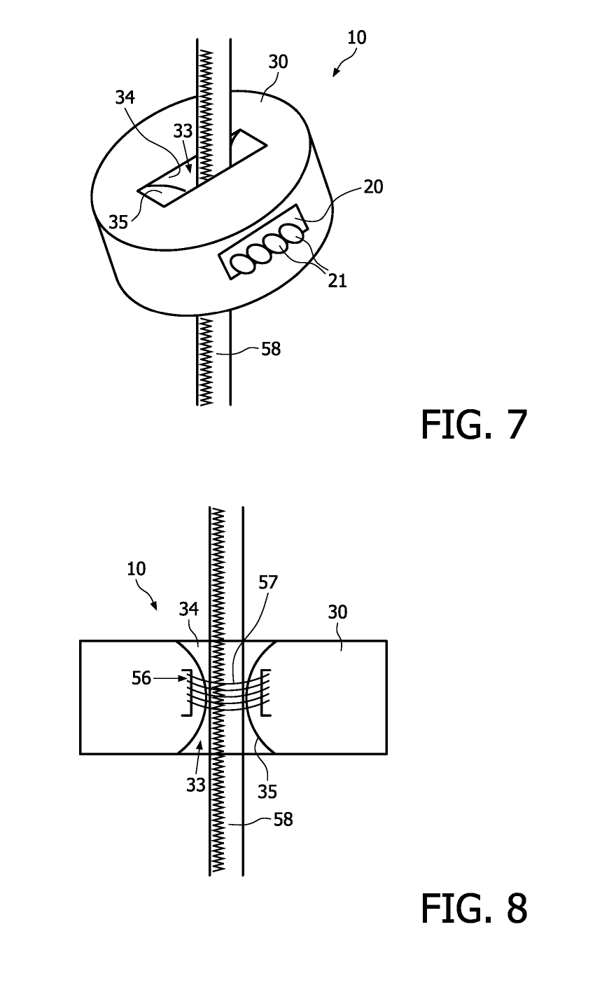

FIGS. 7 and 8 show a float 30 and a portion of a guiding rod 58 of a third advantageous embodiment of water level indicating means 10 for use in the hot water kettle 1. In this embodiment, the float 30 is mounted in such a way that its orientation with respect to a direction in which the guiding rod 58 is extending is variable with an orientation of the water surface 11. In particular, the hole 33 of the float 30, through which the guiding rod 58 is extending, has a specific shape, wherein the hole 33 is smallest at its centre, and largest at its entrances. In the shown example, the hole 33 is delimited by two planar inner surfaces 34 and two circular inner surfaces 35 of the float 30. Due to the presence of the circular inner surfaces 35, there is room for the float 30 to pivot with respect to the guiding rod 58 when the container 2 is tilted and the water surface 11 is not at right angles with respect to the direction in which the guiding rod 58 is extending. Hence, when a user puts the container 2 to a diagonal position for the purpose of pouring water from the container 2, for example, an appealing effect is obtained on the basis of the fact that a water level indication bar formed by the row of LEDs 21 remains horizontal with the water level.

Within the scope of the present invention, it is not necessary to have a float 30, as other means for establishing a direct link between the water level and the position of the light(s) of the lighting member 20 may be applied. For example, a lever construction may be provided, wherein the container 2 loads one arm of the lever, and wherein the light(s) of the lighting member 20 are arranged on another arm of the lever. In such a case, in order to have good results, it is important that the lever construction is accurately calibrated for the type of fluid that is used in the container 2, for example water. The direct link between the water level and the position of the light(s) of the lighting member 20 is obtained on the basis of the fact that when the fluid level rises, the arm of the lever which is loaded by the container 2 goes down, and the arm carrying the light(s) goes up, and when the fluid level falls, the arm of the lever which is loaded by the container goes up, and the arm carrying the light(s) goes down.

Furthermore, in case a float 30 is applied, it is not necessary for the lighting member 20 to be arranged in the float 30. Therefore, in case the lighting member 20 comprises one or more LEDs 21, another way of preventing these LEDs 21 from getting subjected to a temperature that is too high is having the LEDs 21 arranged outside of the float 30, wherein the lighting member 20 carrying the LEDs 21 is arranged such as to be movable. In such a case, a coupling between the position of the float 30 and the position of the lighting member 20 may be established through a mechanical connection. Another possibility involves placing a magnet in the float 30 and attaching a magnet to the lighting member 20, so that the lighting member 20 may be moved under the influence of magnetic force.

In the shown examples, the float 30, which is used for carrying the lighting member 20, is guided on a pair of guiding wires 40 or a single guiding rod 58, wherein movements of the float 30 in a sideward direction are prevented. Nevertheless, within the scope of the present invention, it is not necessary to apply any guiding means, especially in case there is no need for a location of the lighting member 20 to be fixed in a sideward direction.

It will be clear to a person skilled in the art that the scope of the present invention is not limited to the examples discussed in the foregoing, but that several amendments and modifications thereof are possible without deviating from the scope of the present invention as defined in the attached claims. While the present invention has been illustrated and described in detail in the figures and the description, such illustration and description are to be considered illustrative or exemplary only, and not restrictive. The present invention is not limited to the disclosed embodiments.

Variations to the disclosed embodiments can be understood and effected by a person skilled in the art in practicing the claimed invention, from a study of the figures, the description and the attached claims. In the claims, the word “comprising” does not exclude other steps or elements, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope of the present invention.

In the foregoing, an electric hot water kettle 1 which comprises a container 2 for containing water to be heated is disclosed. In order to provide a user of the kettle 1 with information regarding a level of water that is present inside the container 2, so that the user may know whether the container 2 needs to be filled, the kettle 1 comprises water level indication means 10. These means 10 comprise a lighting member 20 having at least one light 21. Advantageously, these means 10 also comprise a float 30 that is capable of floating on water, and is arranged in the container 2 or another section of the kettle 1 containing water, which section is in communication with the container 2. The lighting member 20 may be arranged in the float 30, and in such a case, the at least one light 21 moves along with the water surface 11 by means of the float 30, as a result of which a most accurate indication of the water level is obtained. For the purpose of powering the at least one light 21 of the lighting member 20, it is possible to apply power supplying means 50 having a pickup coil 57 which is arranged in the float 30 and which is connected to the light 21, wherein an inductive coupling between the pickup coil 57 and a coil 55 connected to the mains 52 exists.

1. Device (1) having a container (2) for containing fluid, and means (10) for indicating a level of fluid which is present inside the container (2), wherein the fluid level indicating means (10) comprise a movably arranged lighting member (20) having at least one light (21) for emitting light, and linking means for establishing a direct link between a position of the lighting member (20) and a level of the fluid that is present inside the container (2).

2. Device (1) according to claim 1, wherein the linking means comprise a float (30), which is adapted to float on the fluid.

3. Device (1) according to claim 2, wherein the lighting member (20) is arranged in the float (30).

4. Device (1) according to claim 3, having means (50) for supplying power to the lighting member (20), wherein the power supplying means (50) comprise a combination of a member (51, 55) for transmitting power and a member (54, 57) for receiving power transmitted by the power transmitter (51, 55), wherein the power transmitter (51, 55) is arranged in a wall of the container (2), and wherein the power receiver (54, 57) is arranged in the float (30) and coupled to the lighting member (20).

5. Device (1) according to claim 4, wherein the power transmitter (51, 55) and the power receiver (54, 57) are coupled through an inductive link, and wherein both the power transmitter (51, 55) and the power receiver (54, 57) comprise a coil (55, 57).

6. Device (1) according to claim 5, wherein the power receiver (54, 57) is arranged on a ferrite rod (58).

7. Device (1) according to claim 4, wherein the power supplying means (50) comprise energy storing means such as a battery or a capacitor, wherein the lighting member (20) is coupled to the energy storing means, and wherein the energy storing means are coupled to the power receiver (54, 57).

8. Device (1) according to claim 3, having a member (58) for guiding the float (30), wherein the float (30) has a hole (33) for letting through the guiding member (58), wherein the float (30) is slidably arranged with respect to the guiding member (58), and wherein the float (30) is also pivotally arranged with respect to the guiding member (58).

9. Device (1) according to claim 2, wherein the lighting member (20) is arranged outside of the float (30).

10. Fluid level indicating means (10) for a device (1) having a container (2) for containing fluid, comprising a float (30) which is adapted to floating on the fluid, and a lighting member (20) having at least one light (21) for emitting light, wherein the lighting member (20) is arranged in the float (30).

11. Assembly of a float (30) which is adapted to floating on fluid and a lighting member (20) having at least one light (21) for emitting light, wherein the lighting member (20) is arranged inside the float (30).
